(19) United States
(12) Patent Application Publication
(10) Pub. No.: US 2010/0294169 A1
(43) Pub. Date: Nov. 25, 2010

(54) CONCRETE BLOCK

(76) Inventors: Dan Clark, Minneapolis, MN (US); Ralph Nelson, Minneapolis, MN (US); Don Vu, Richfield, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/841,437

(22) Filed: Jul. 22, 2010

Related U.S. Application Data
(63) Continuation of application No. 11/843,439, filed on Aug. 22, 2007.

(51) Int. Cl. C04B 18/06

(52) U.S. Cl. 106/707

(57) ABSTRACT

The present invention includes concrete block comprising one or more of limestone, volcanic ash, shellfish shells, seashells, rice hull ash, slag, fly ash, or any suitable combination of the same. The present invention further includes concrete block having one or more facial surface structures on one or more sides of the concrete block. The facial surface structures may include the structures referred to and illustrated herein as Socket Block, Fold Block, Bracket Block, Awning Block, Chisel Block, Spade Block, Shim Block, Pachinko Block, Tornado Block, Ripple Block, Sine Block, or Egg Block.

### FIELD OF THE INVENTION

The present disclosure relates to apparatus and methods for concrete block. More particularly, the present disclosure relates to apparatus and methods for concrete block having new structures, particularly facial structures.

### BRIEF SUMMARY OF THE INVENTION

The present invention, in one embodiment, is concrete block comprising one or more of limestone, volcanic ash, shellfish shells, seashells, rice hull ash, slag, fly ash, or any suitable combination of the same.

The present invention in another embodiment is concrete block having one or more facial surface structures on one or more sides of the concrete block. The facial surface structures may include the structures referred to and illustrated herein as Socket Block, Fold Block, Bracket Block, Awning Block, Chisel Block, Spade Block, Shim Block, Pachinko Block, Tornado Block, Ripple Block, Sine Block, or Egg Block.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIGS. 1A-B include multiple views of a concrete block having a Socket Block facial structure.

FIGS. 2A-D include multiple views of a concrete block having a Fold Block facial structure.

FIGS. 3A-D include multiple views of a concrete block having a Bracket Block facial structure.

FIGS. 4A-D include multiple views of a concrete block having a Awning Block facial structure.

FIGS. 5A-D include multiple views of a concrete block having a Chisel Block facial structure.

FIGS. 6A-D include multiple views of a concrete block having a Spade Block facial structure.

FIGS. 7A-D include multiple views of a concrete block having a Shim Block facial structure.

FIGS. 8A-D include multiple views of a concrete block having a Pachinko Block facial structure.

FIGS. 9A-D include multiple views of a concrete block having a Tornado Block facial structure.

FIGS. 10A-D include multiple views of a concrete block having a Ripple Block facial structure.

FIGS. 11A-D include multiple views of a concrete block having a Sine Block facial structure.

FIGS. 12A-D include multiple views of a concrete block having a Egg Block facial structure.

### DETAILED DESCRIPTION

The present disclosure relates to novel and advantageous concrete block. Particularly, the present disclosure relates to concrete block comprising one or more of limestone, volcanic ash, shellfish shells, seashells, rice hull ash, slag, fly ash, or any suitable combination of the same. The present disclosure further relates to concrete block having one or more facial surface structures on one or more sides of the concrete block. The facial surface structures may include the structures referred to and illustrated herein as Socket Block, Fold Block, Bracket Block, Awning Block, Chisel Block, Spade Block, Shim Block, Pachinko Block, Tornado Block, Ripple Block, Sine Block, or Egg Block. Concrete block, as described herein, may be used, for example, but not limited to, structural buildings and walls, retaining walls, or any other structural or non-structural construction or structure, etc. Generally, the concrete blocks may be stacked or aligned in any suitable arrangement or orientation and may or may not be bonded together using mortar or other suitable bonding material.

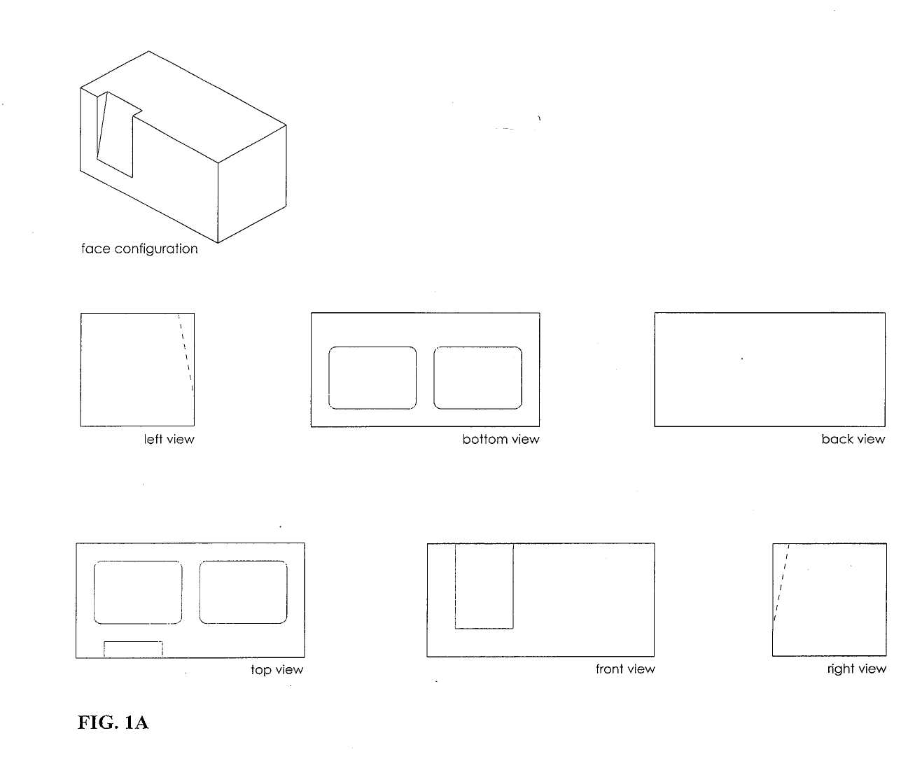

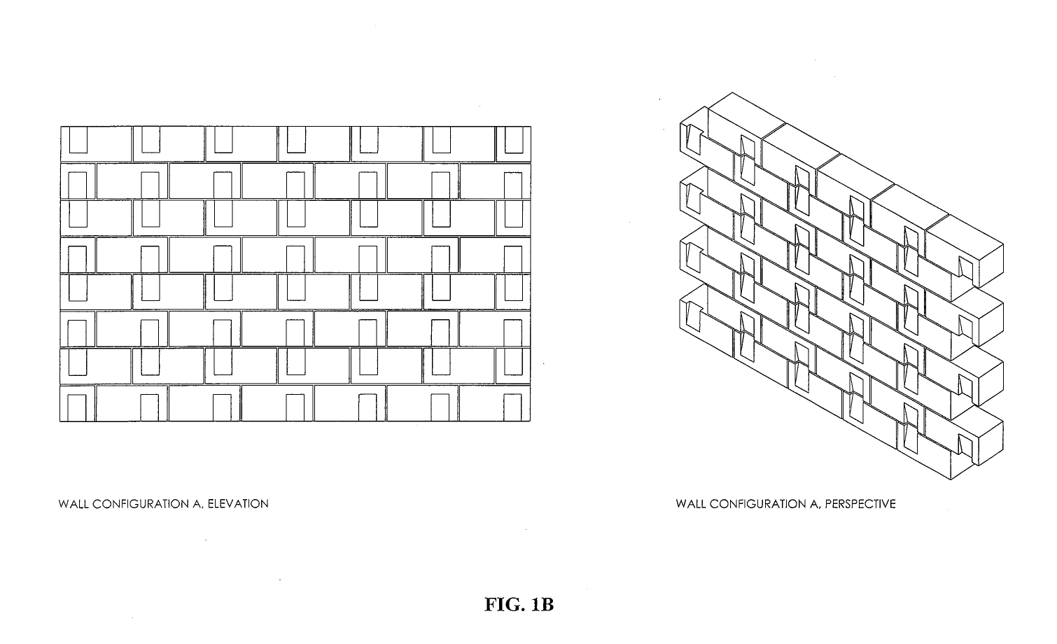

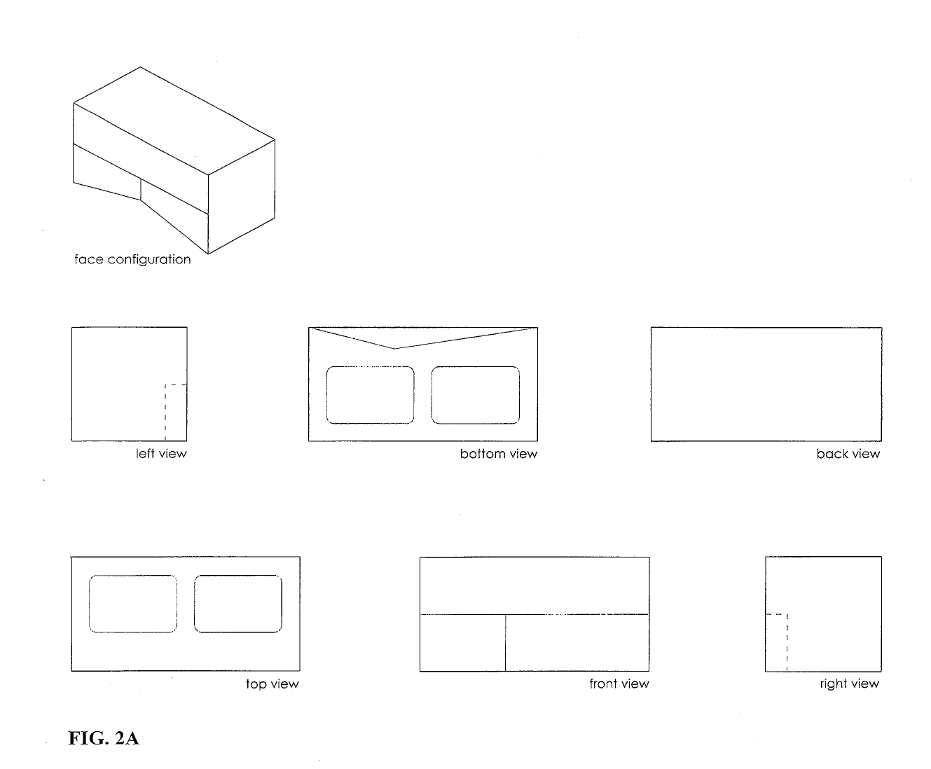

As illustrated in FIGS. 1A-B, a Socket Block may comprise a notch including, but not limited to, a slanted notch. The notch may be created in the thickness of a concrete block side wall.

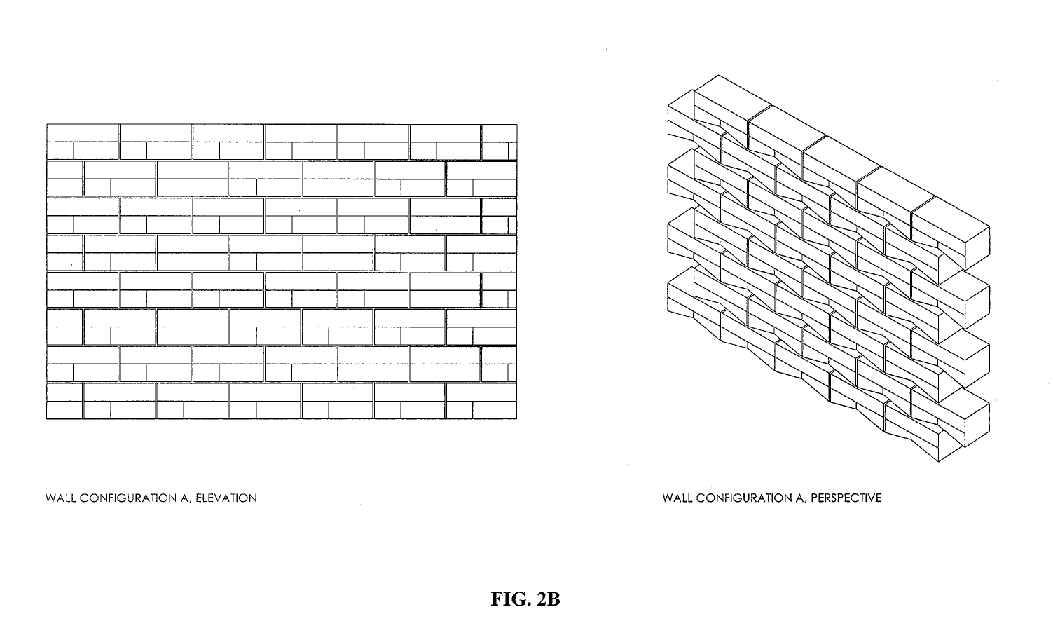

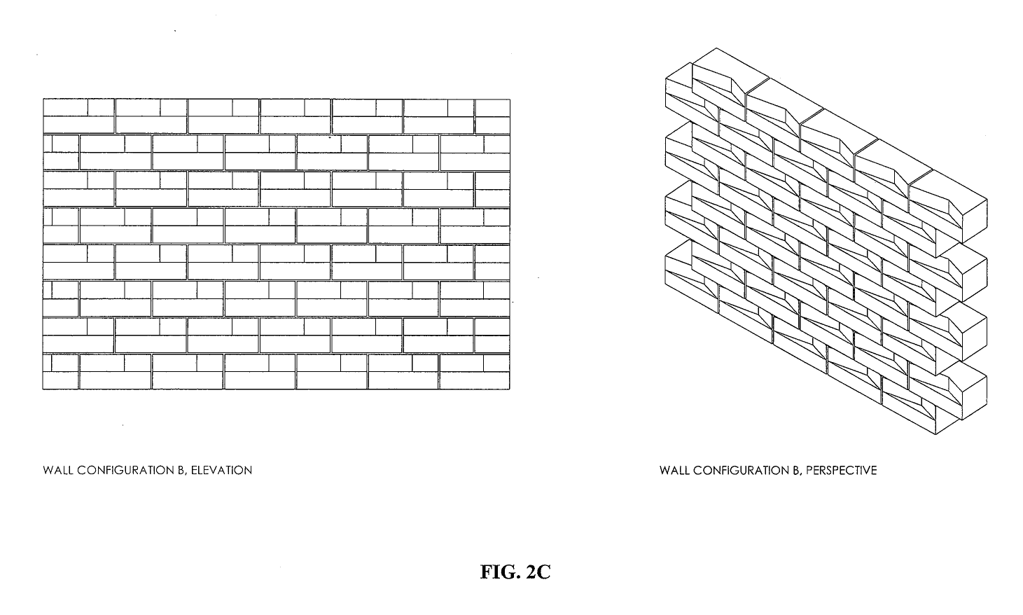

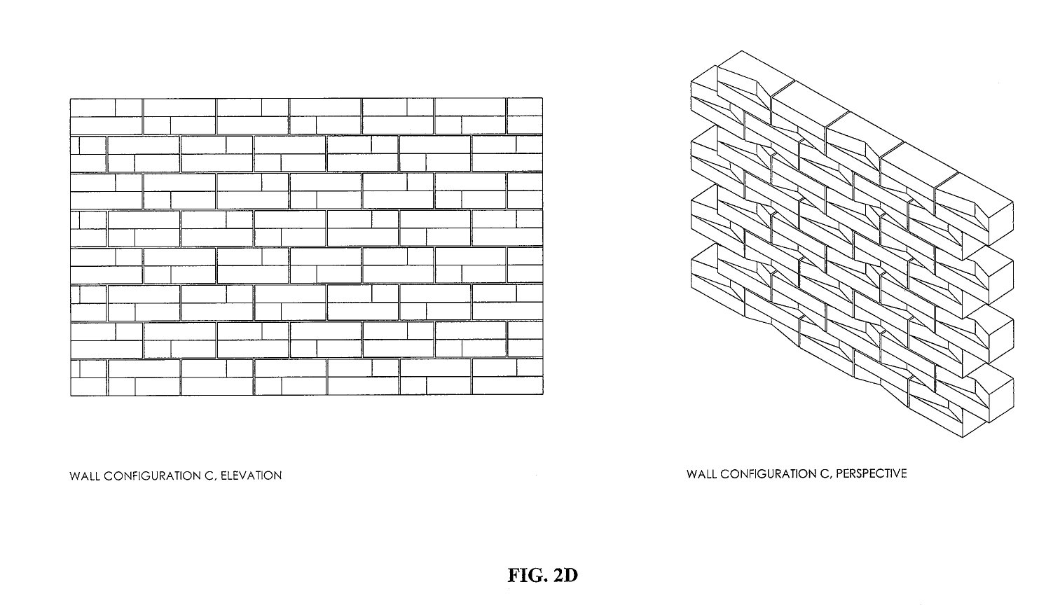

As illustrated in FIGS. 2A-D, a Fold Block may comprise an indented pleat spanning the length of the concrete block. The apex of the pleat may be located at any point along the pleat, between the side edges of the concrete block.

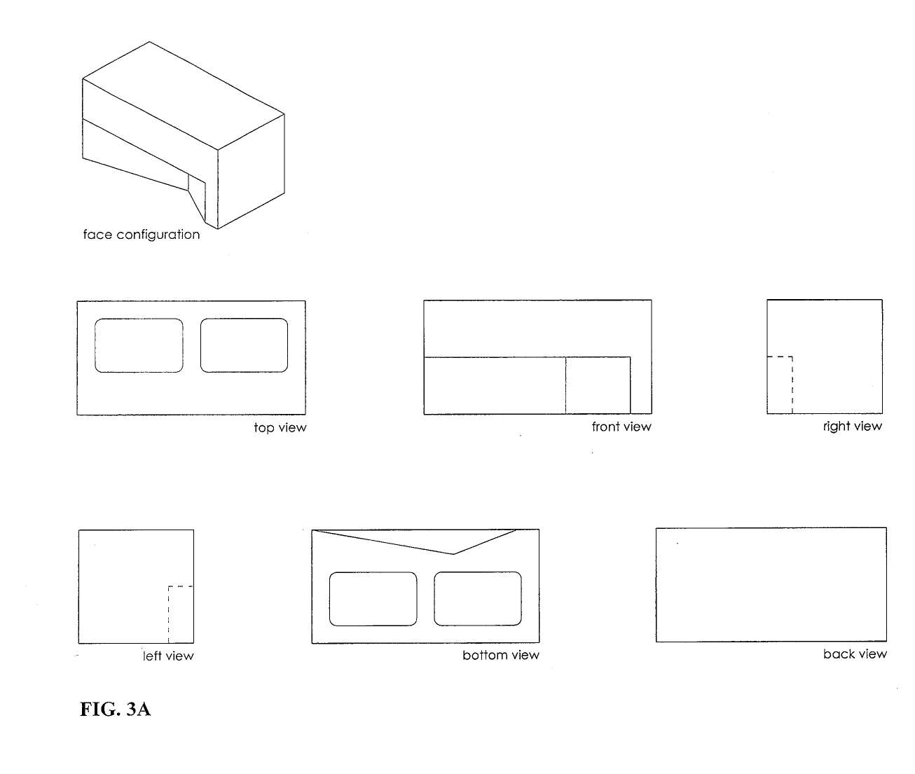

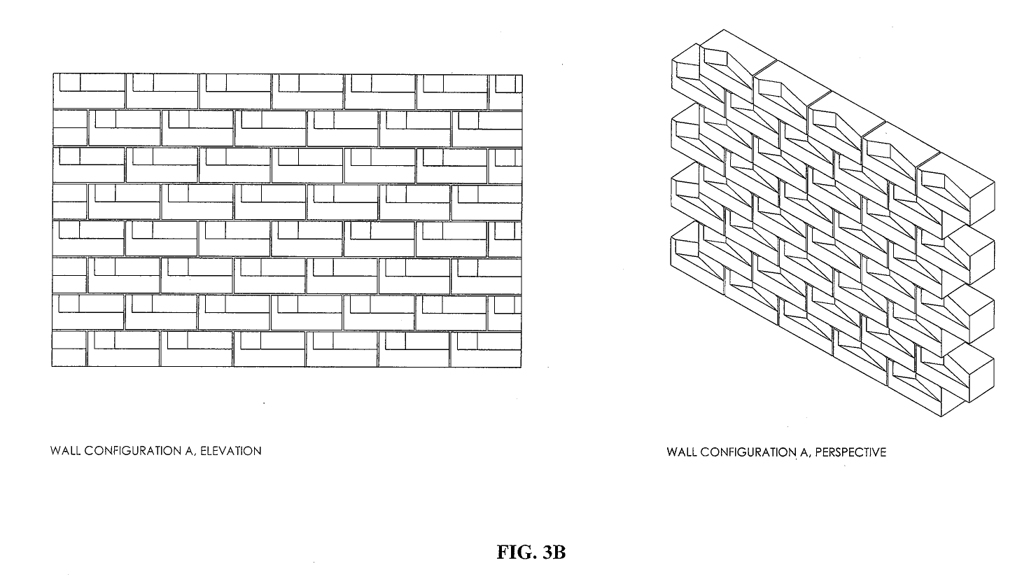

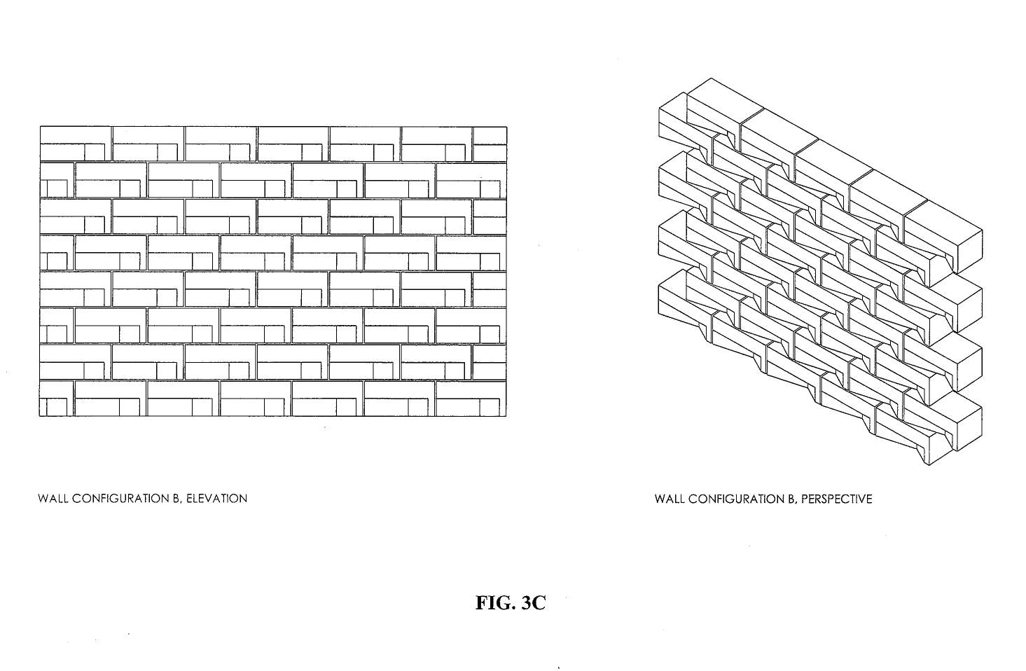

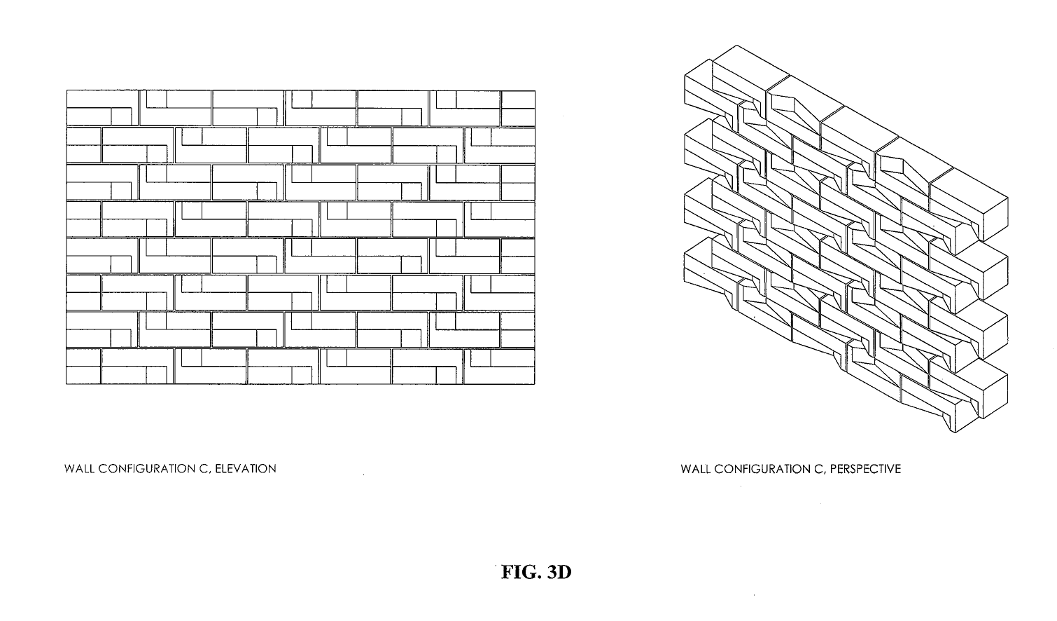

As illustrated in FIGS. 3A-D, a Bracket Block may comprise an indented pleat spanning less than the entire length of the concrete block. The apex of the pleat may be located at any point along the pleat.

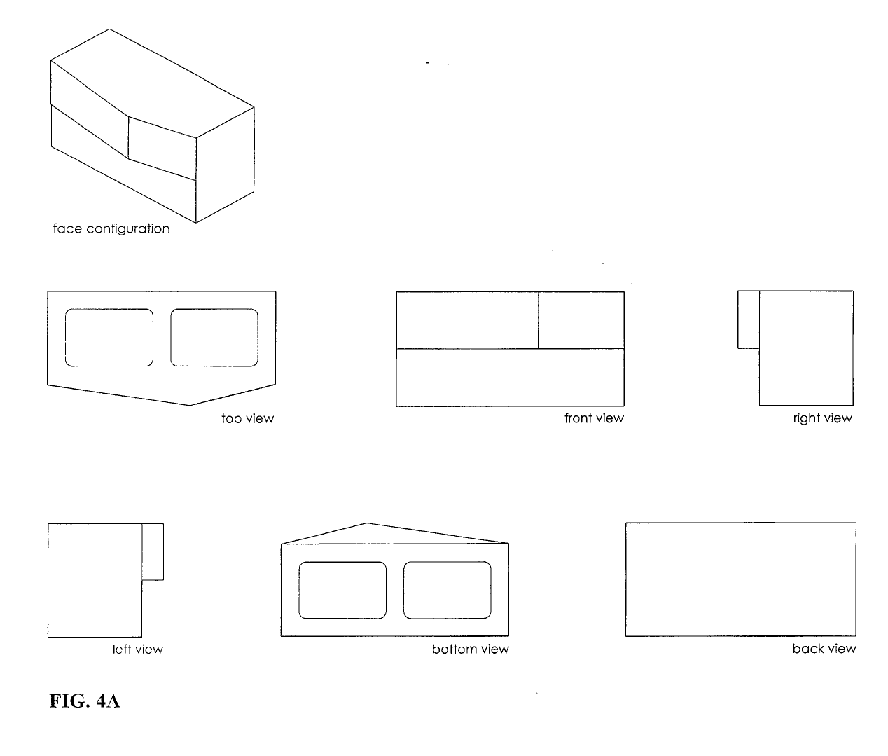

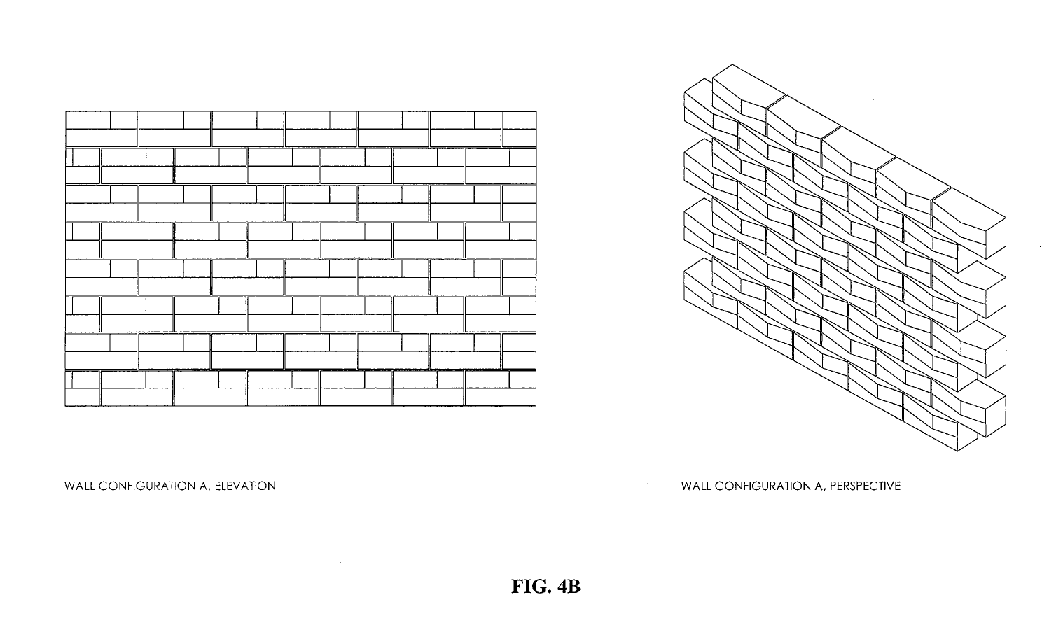

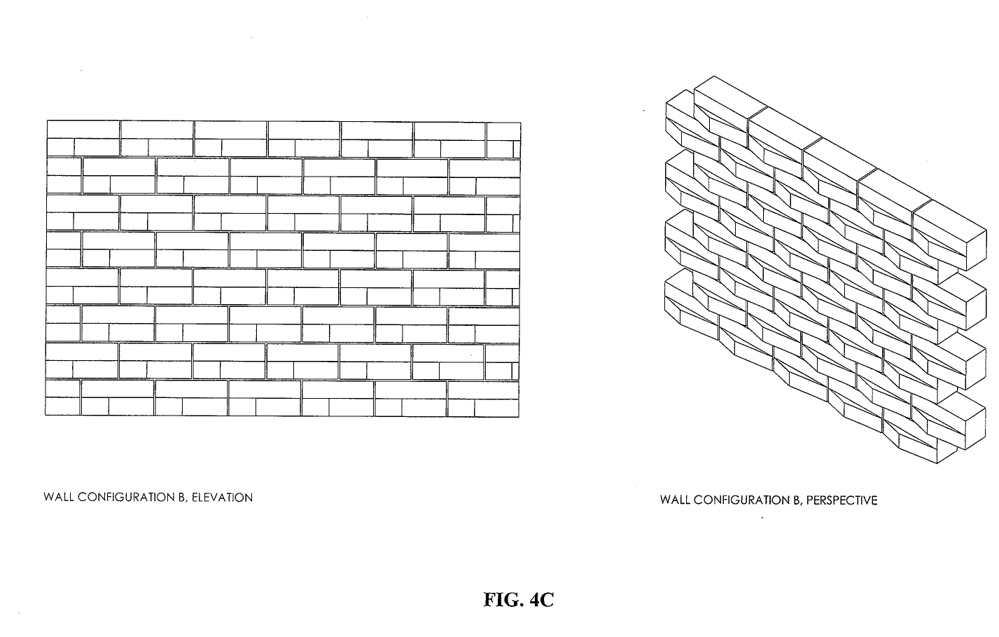

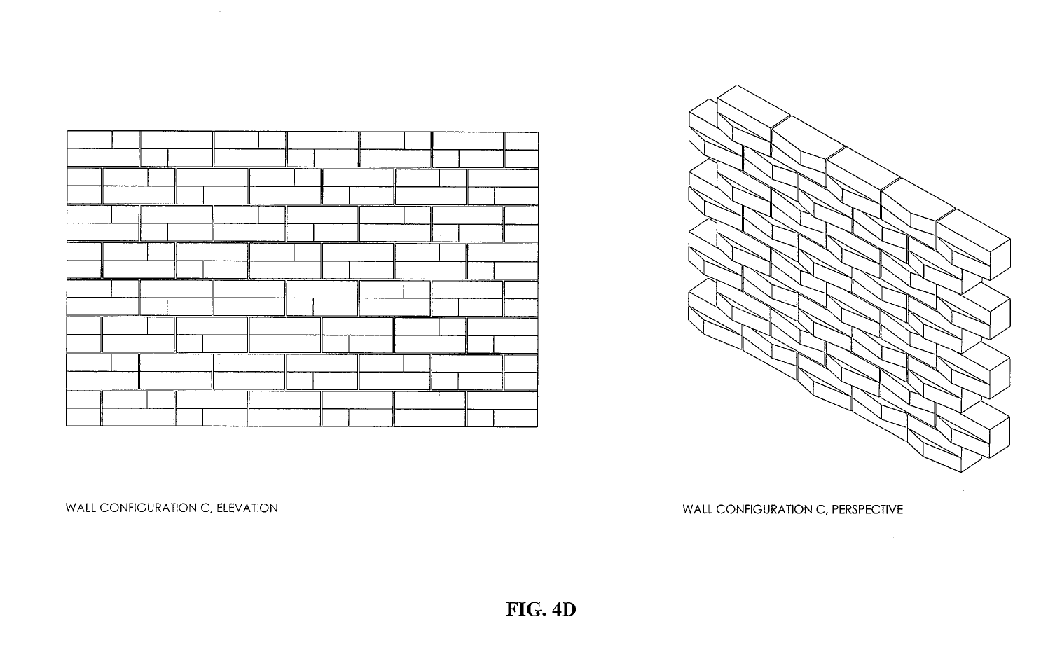

As illustrated in FIGS. 4A-D, an Awning Block may comprise a convex, or protruding, pleat spanning the length of the concrete block. The apex of the pleat may be located at any point along the pleat, between the side edges of the concrete block.

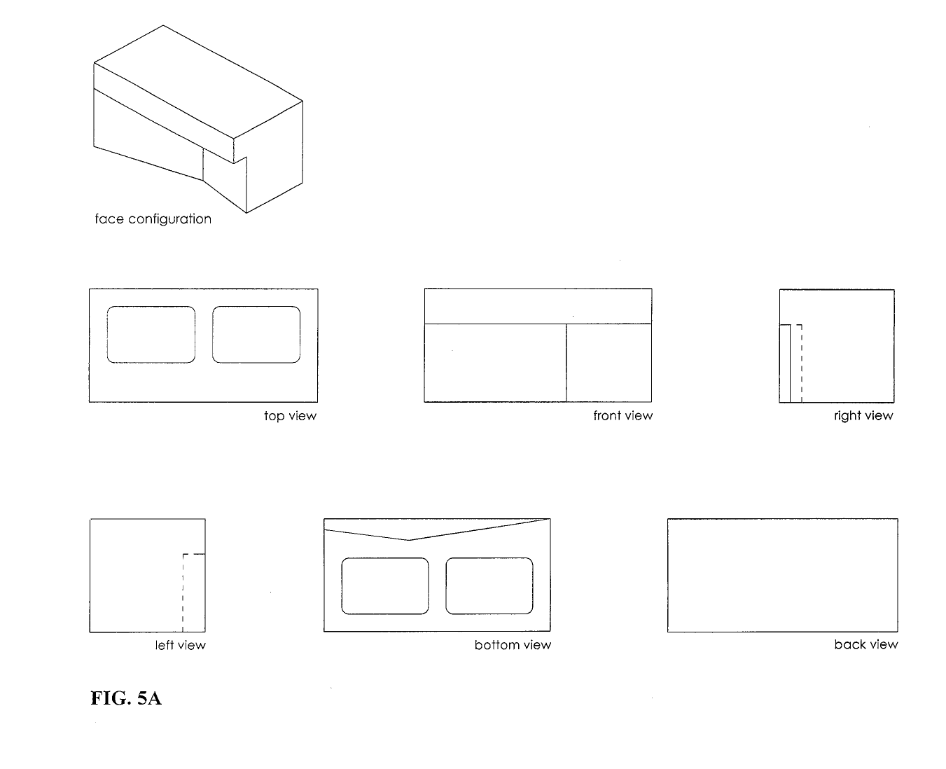

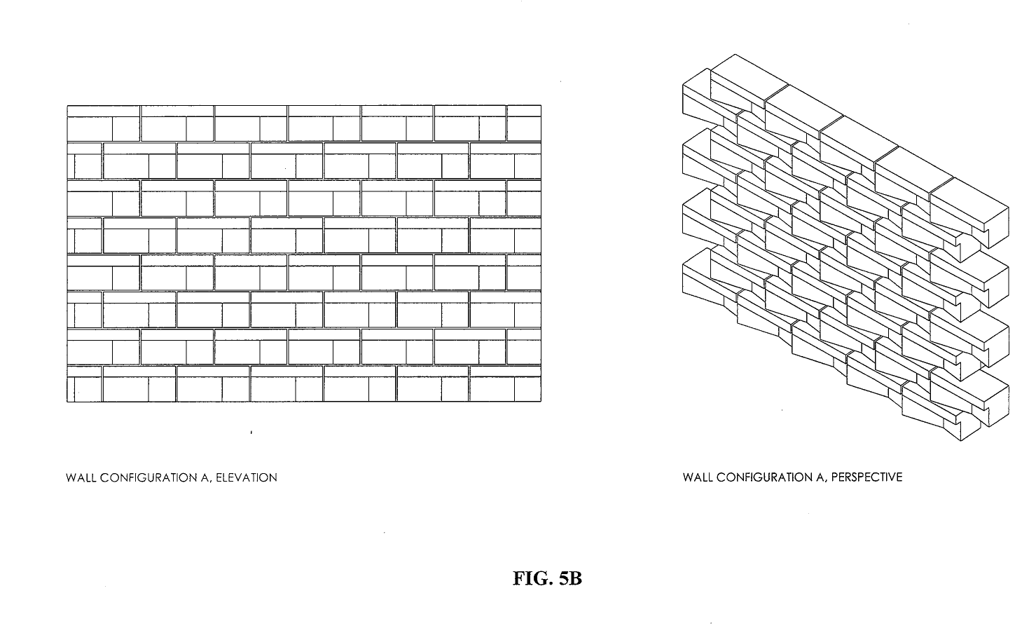

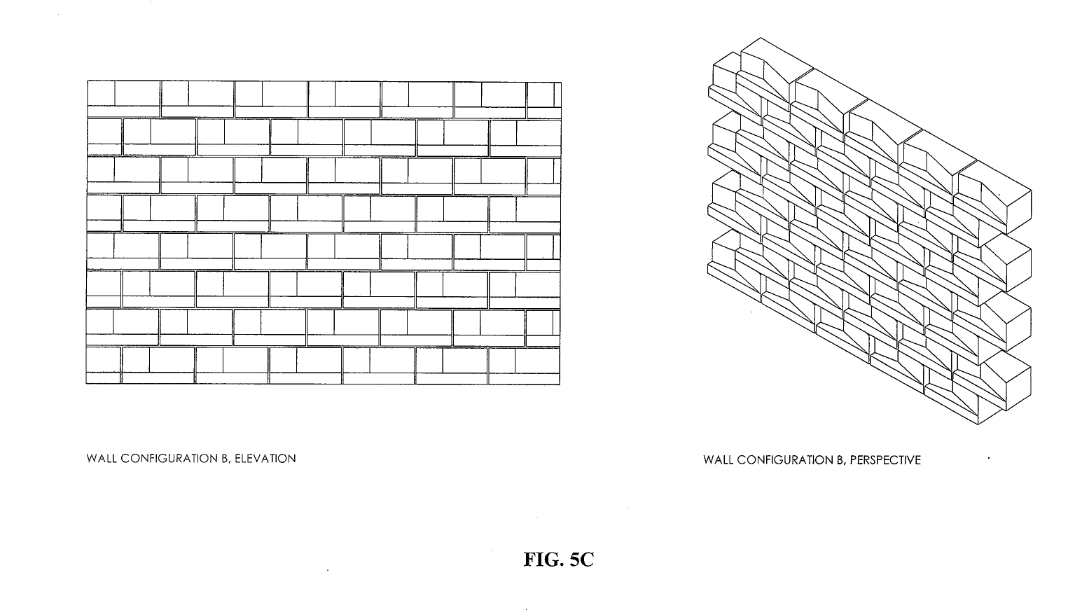

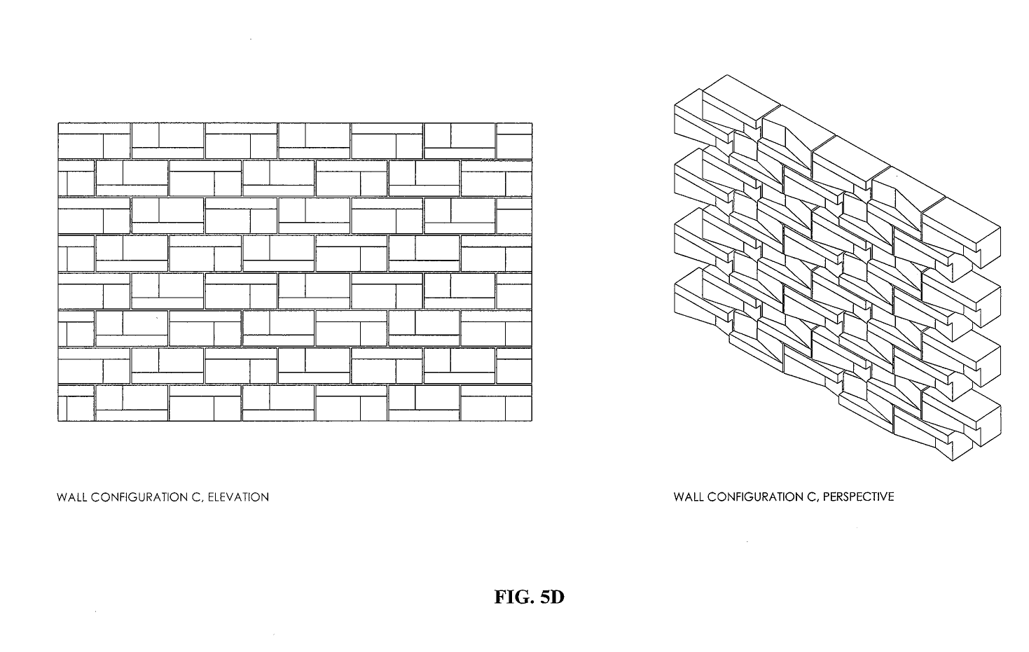

As illustrated in FIGS. 5A-D, a Chisel Block may comprise an indented pleat spanning the length of the concrete block. The apex of the pleat may be located at any point along the pleat, between the side edges of the concrete block. Additionally, at the locations where the sides of the pleat meet the side edges of the concrete block, one or more sides of the pleat may be set back from the surface plane of the concrete block, as can be seen in the perspective, right, and bottom views of FIG. 5A.

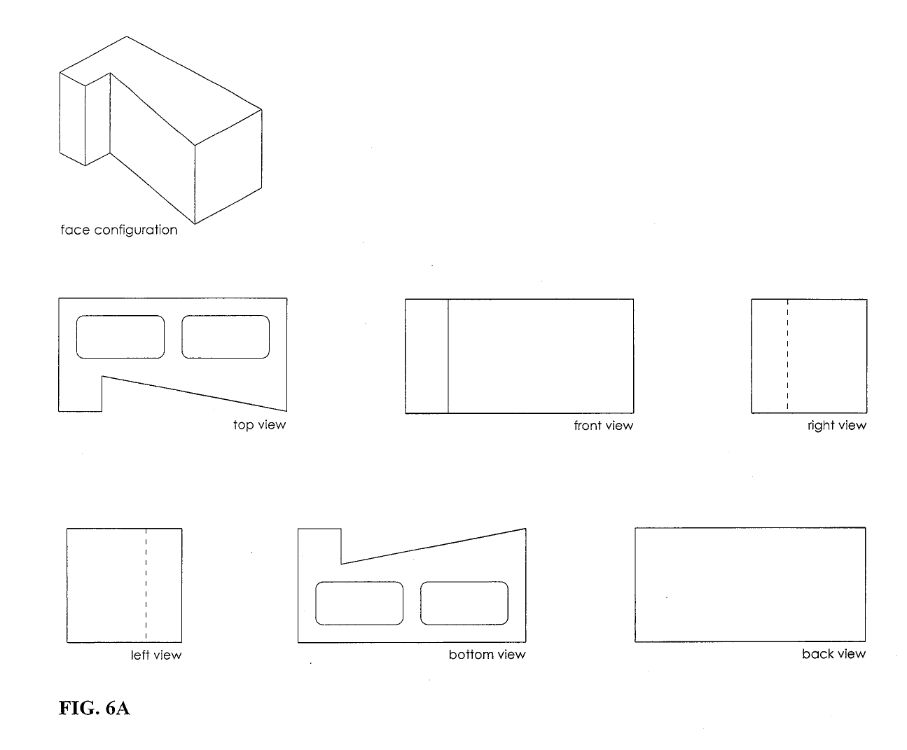

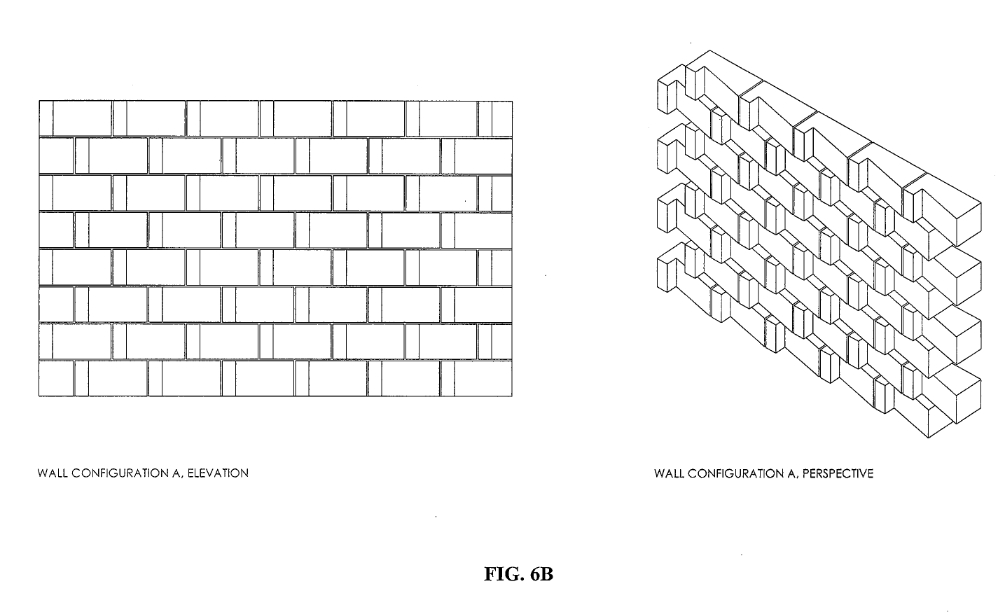

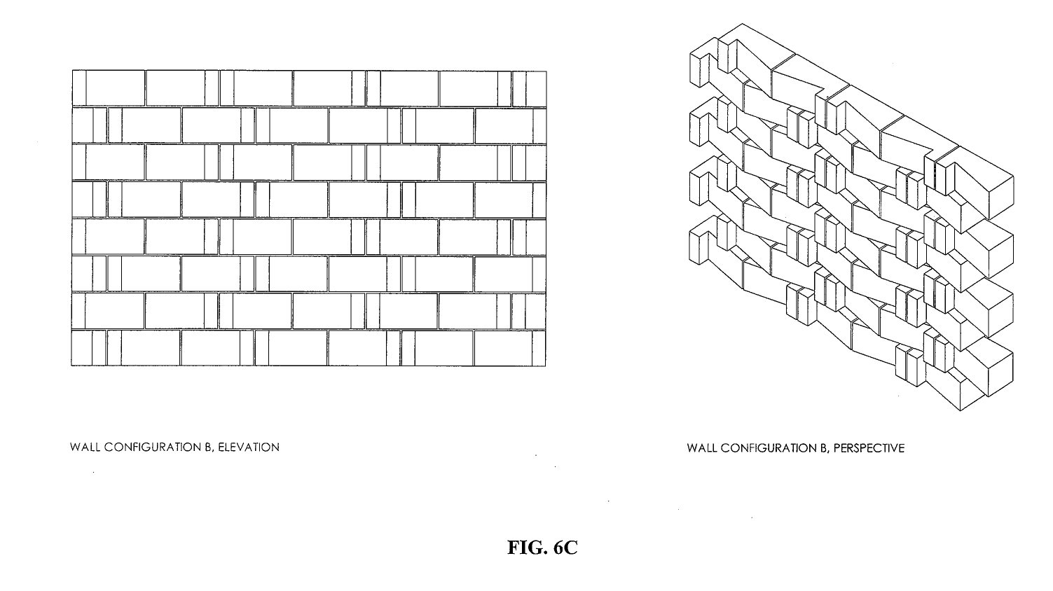

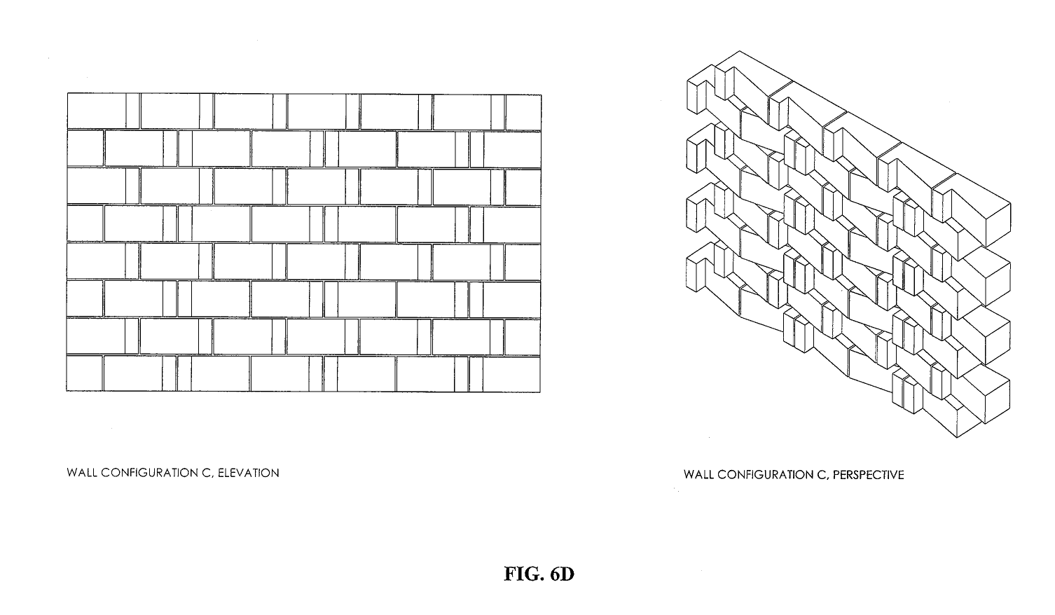

As illustrated in FIGS. 6A-D, a Spade Block may comprise a generally angled cut-out, or indent, in the surface of one or more sides of the concrete block. A cut-out may extend from one edge of the side of the concrete block and stop at some point along the length of the side of the concrete block before reaching the opposite edge of the concrete block, thereby generally creating notch in the surface of the concrete block. The cut-out, or indent, may span the entire width of the concrete block.

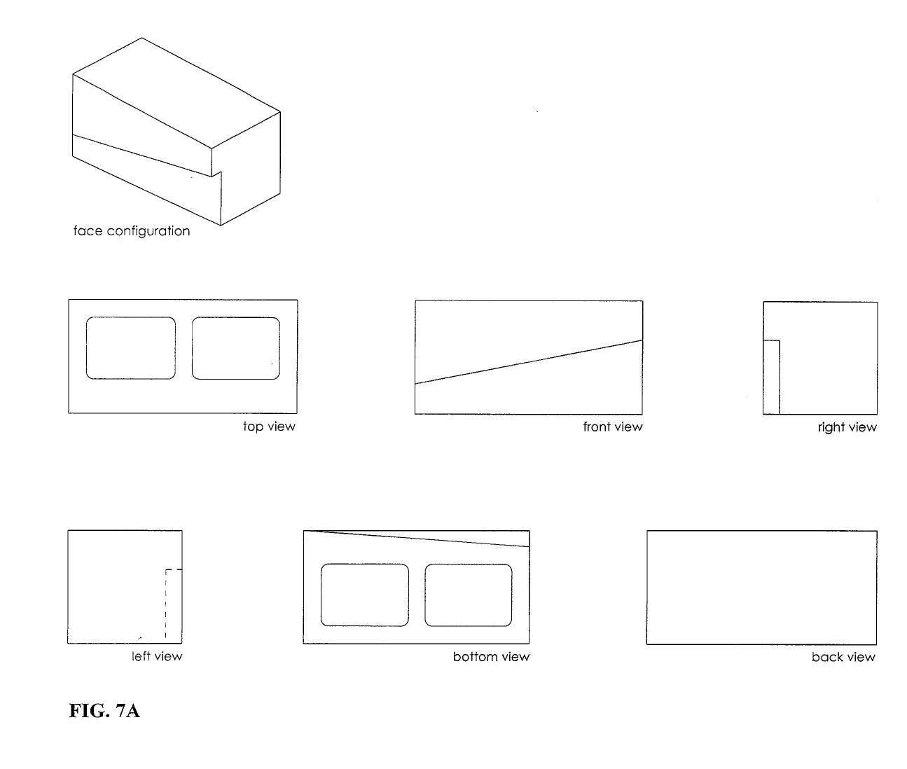

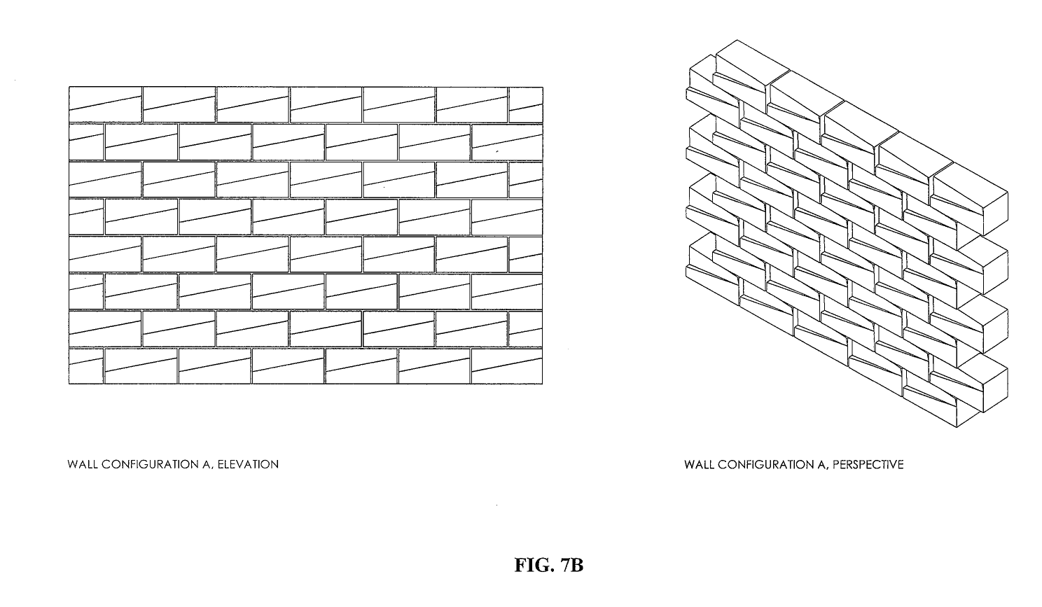

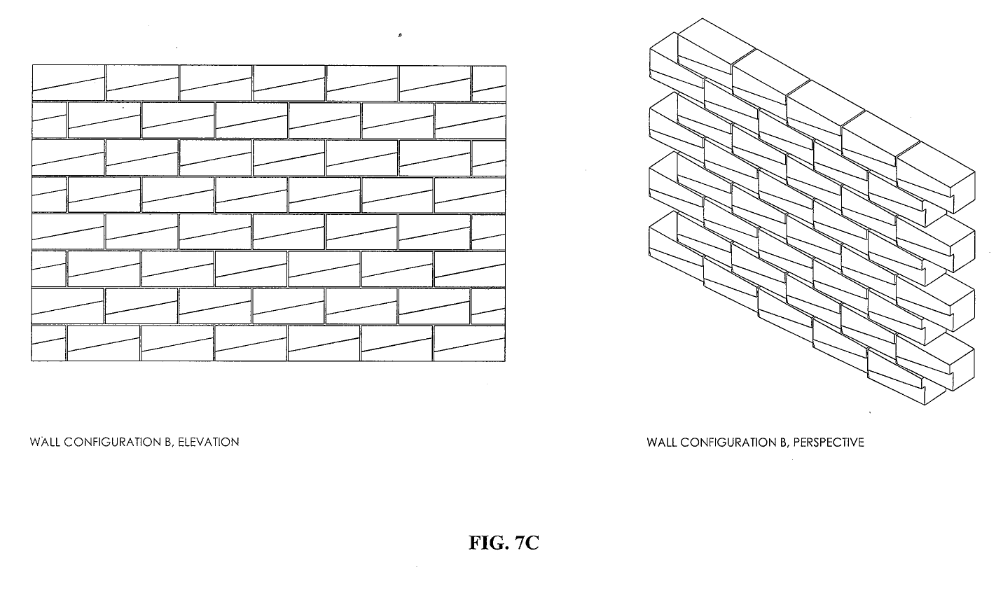

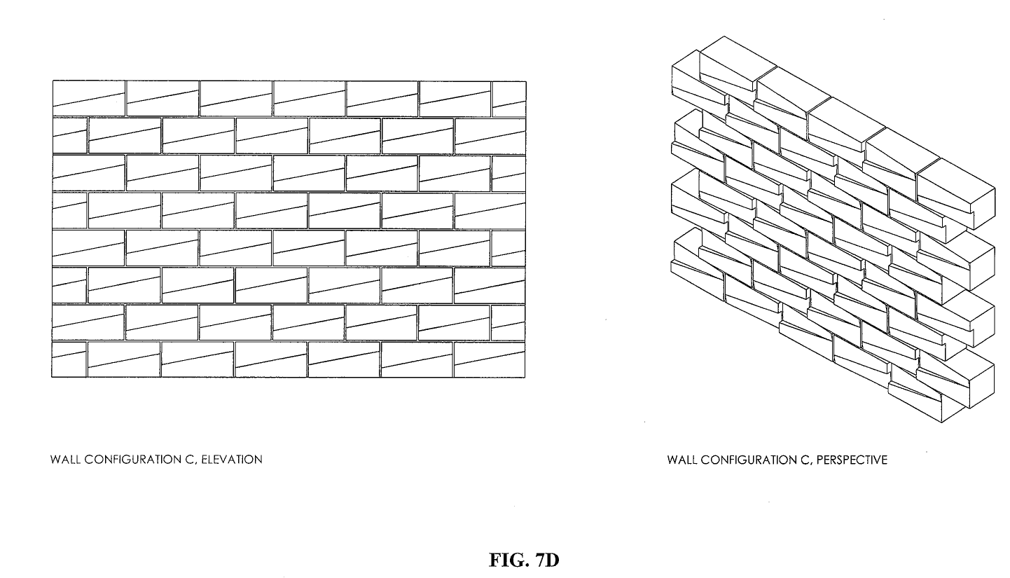

As illustrated in FIGS. 7A-D, a Shim Block may comprise an angled cut-out, or indent, in the surface of one or more sides of the concrete block that extends the length of the concrete block. Additionally, the angled cut-out may span less width at one edge of the side of the concrete block and span more width at the opposite edge of the concrete block, thereby creating an angled edge of the cut-out as can be seen in the perspective and front views of FIG. 7A.

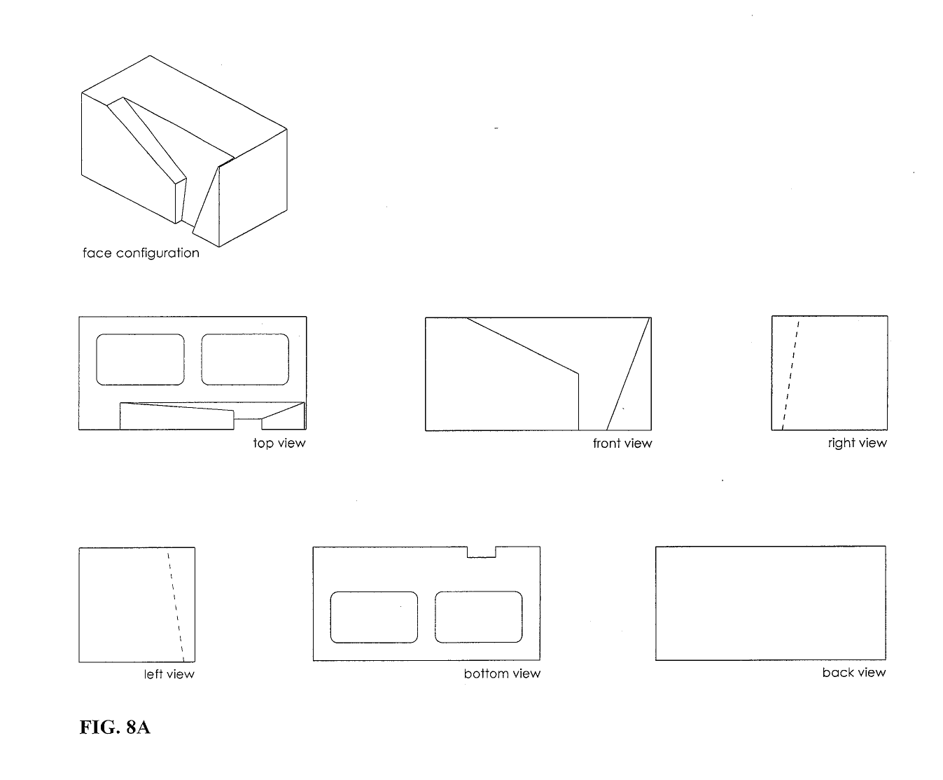

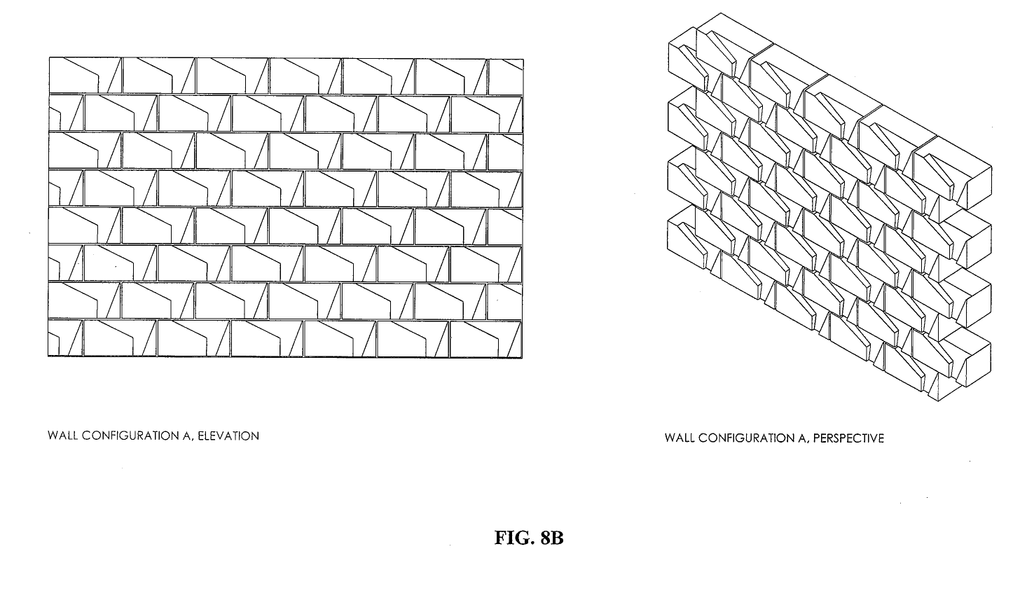

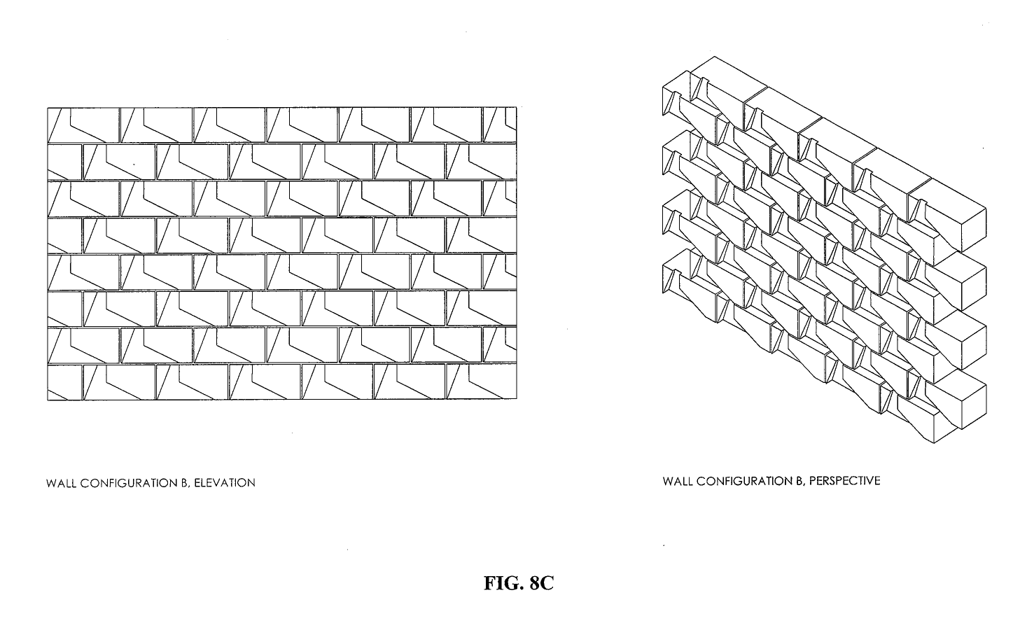

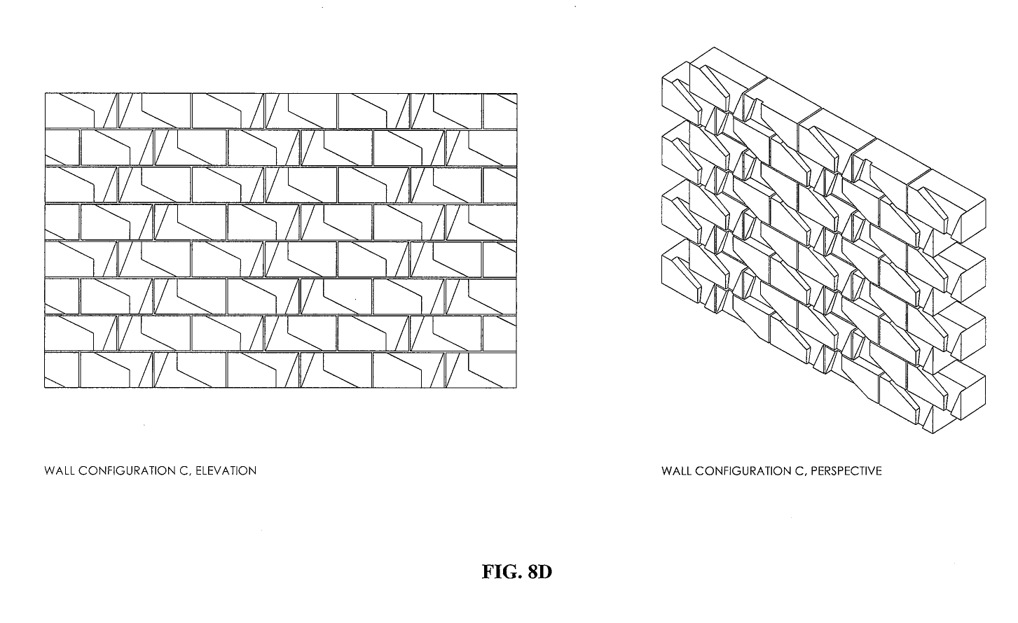

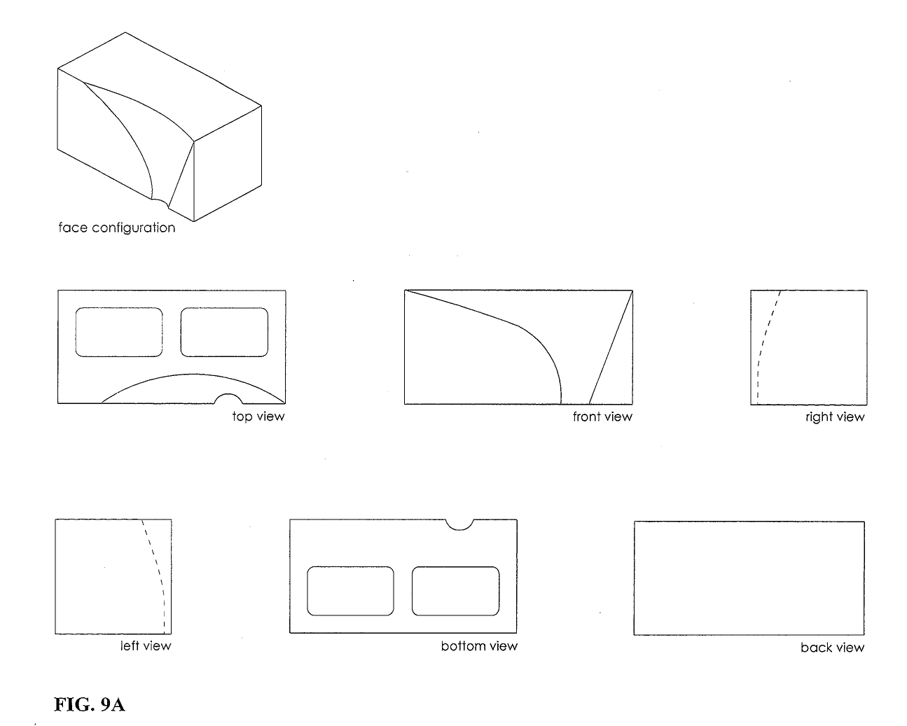

As illustrated in FIGS. 8A-D, a Pachinko Block may comprise an angled slot, or groove, extending across the width of the concrete block. Particularly, one edge of the angled slot, or groove, may comprise one angled wall, while the opposite edge of the angled slot, or groove, may comprise a combination of two angled walls meeting at some point between the side edges of the concrete block.

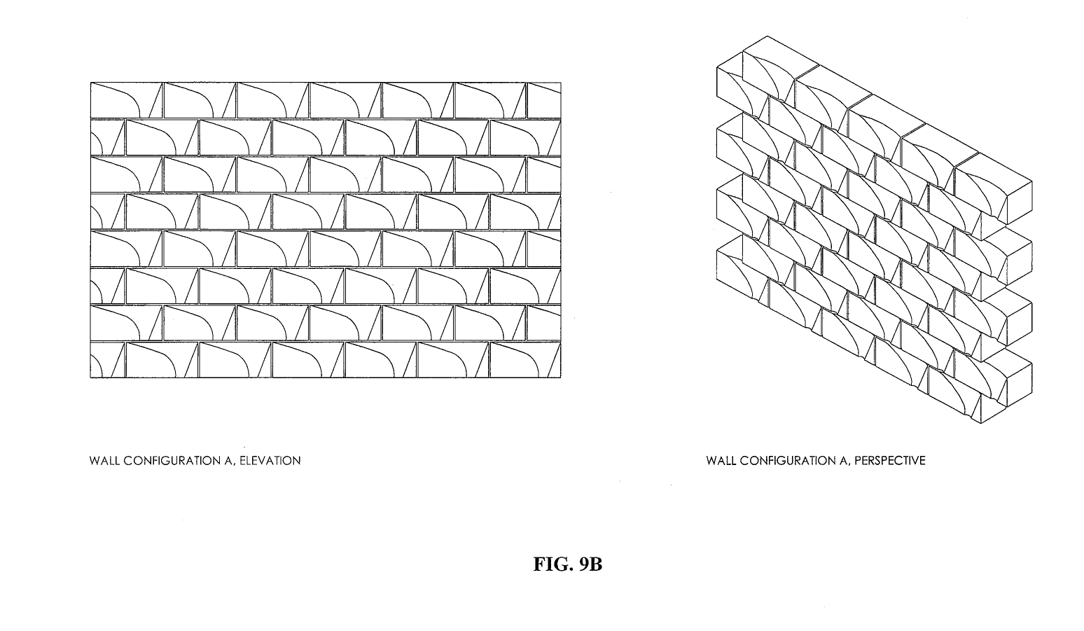

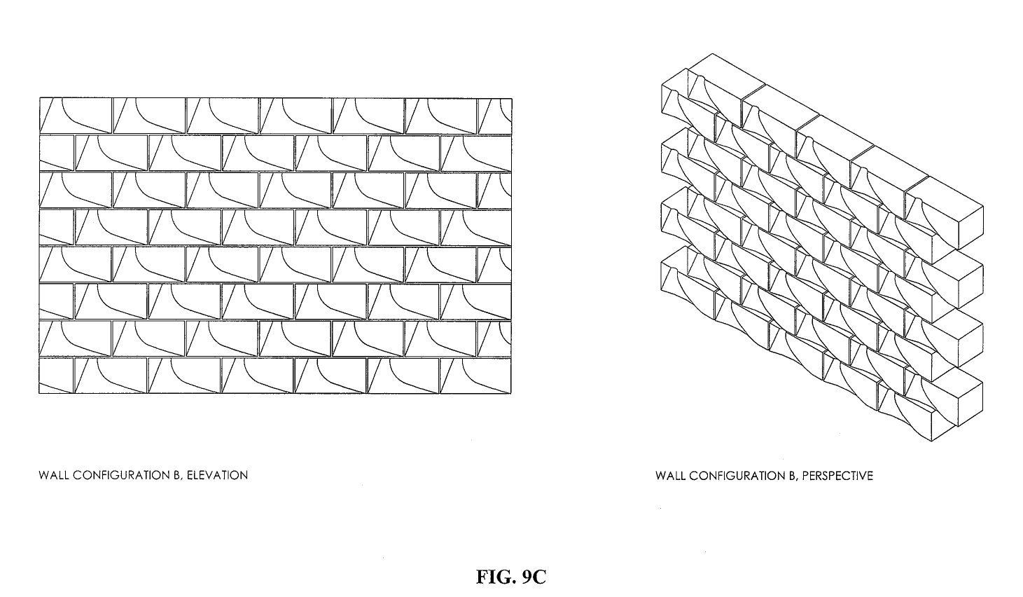

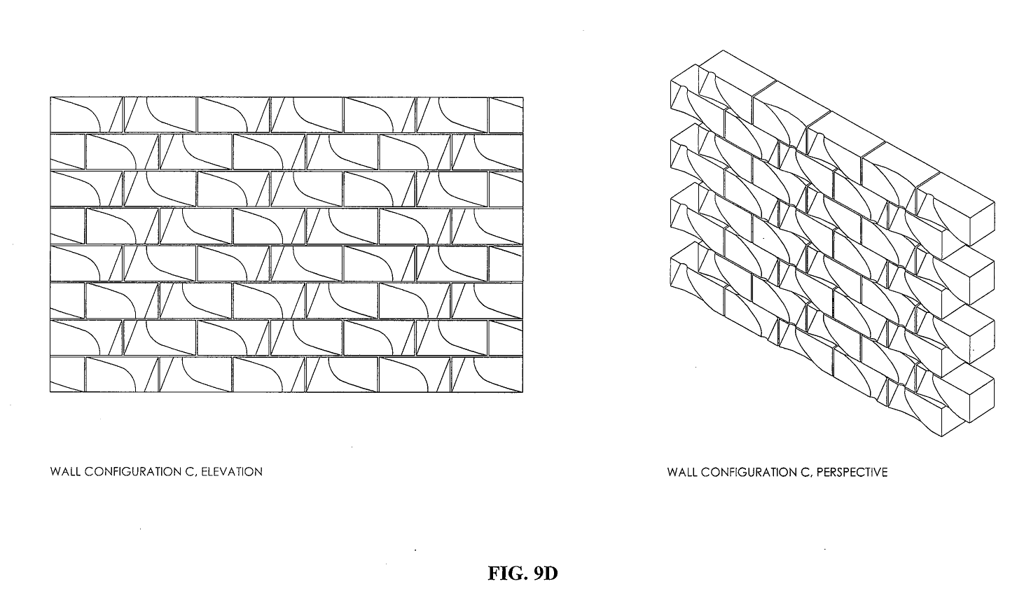

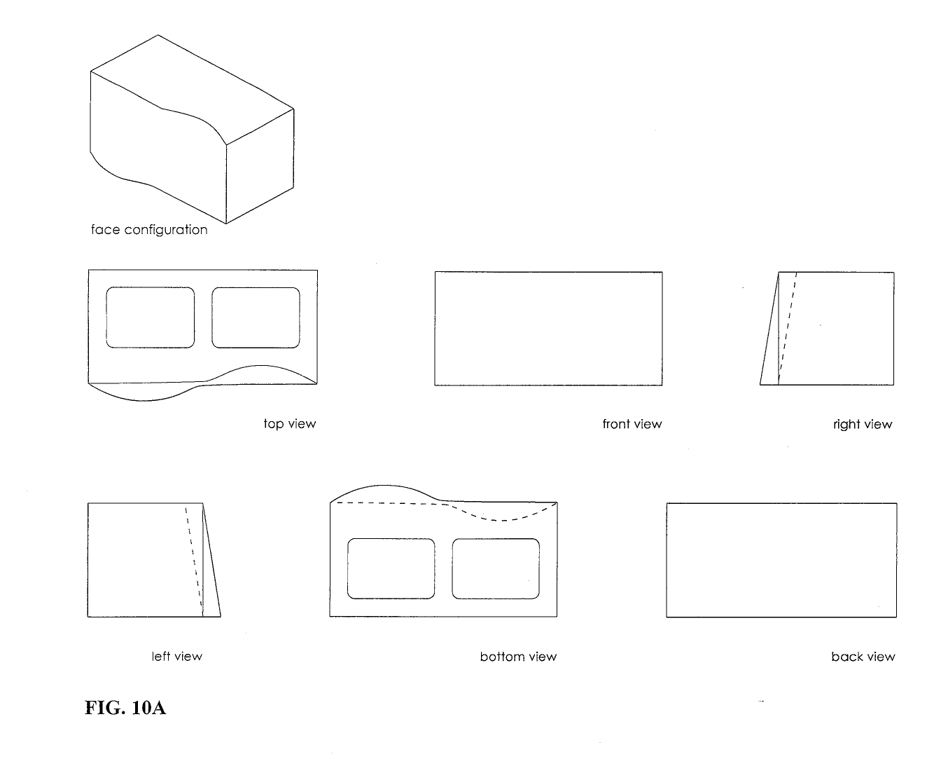

As illustrated in FIGS. 9A-D, a Tornado Block may generally comprise a cross-sectional, tornado-shaped indent in the side of the concrete block. The indent may extend the width of the concrete block.

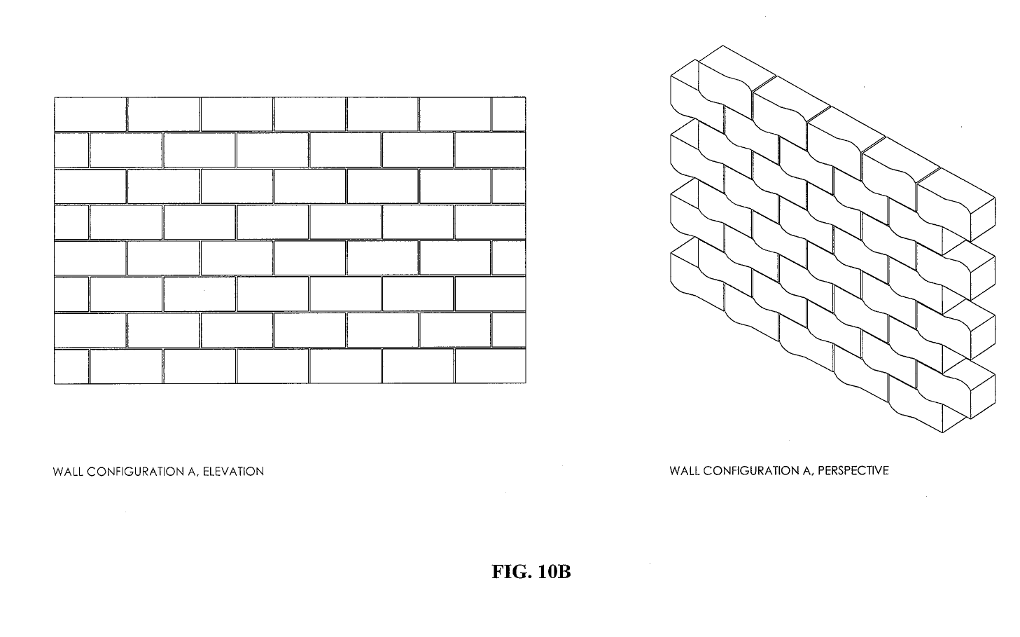

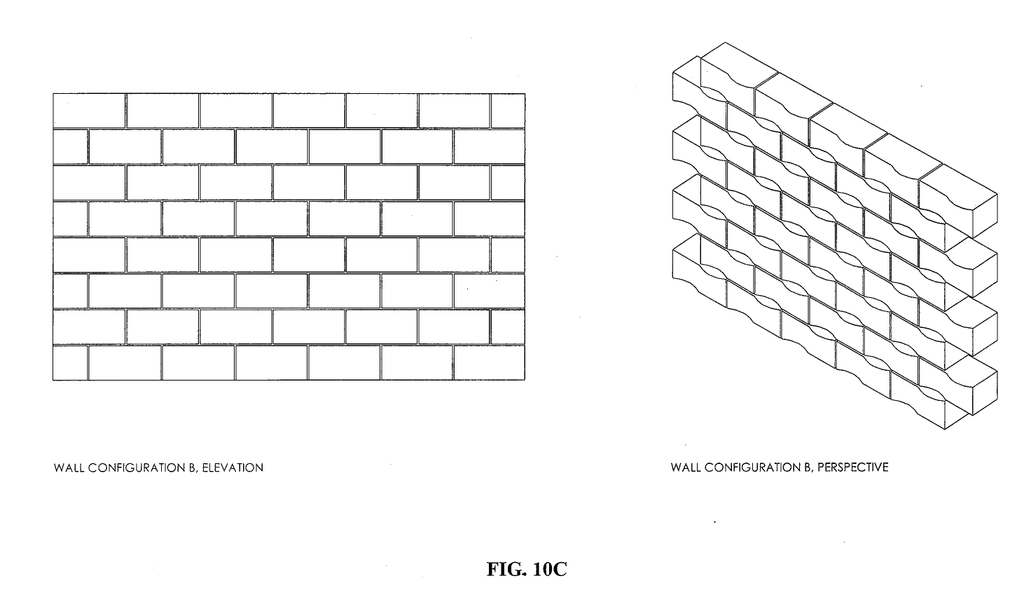

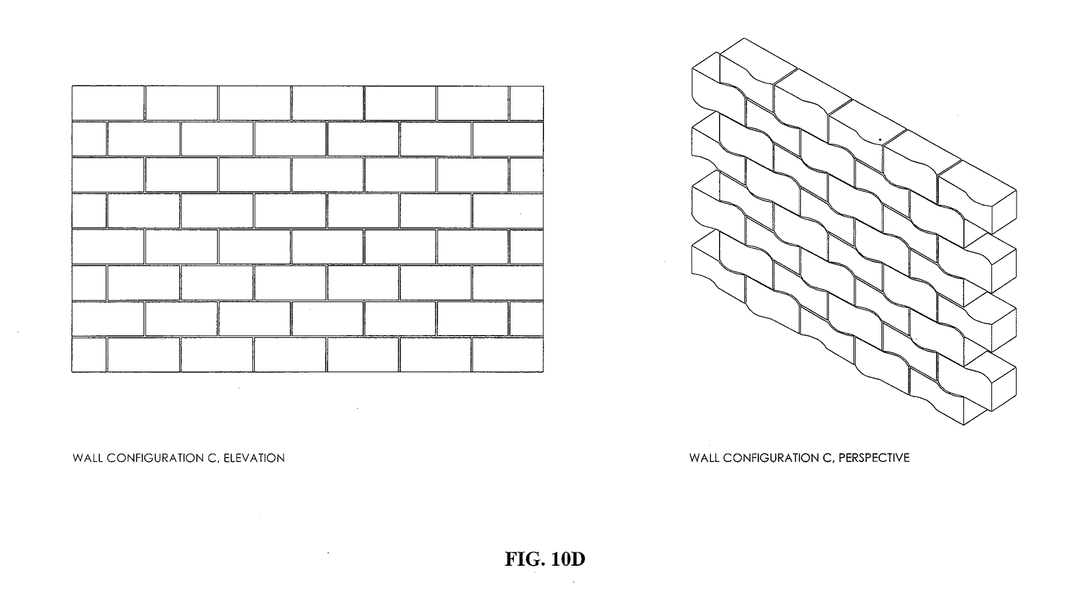

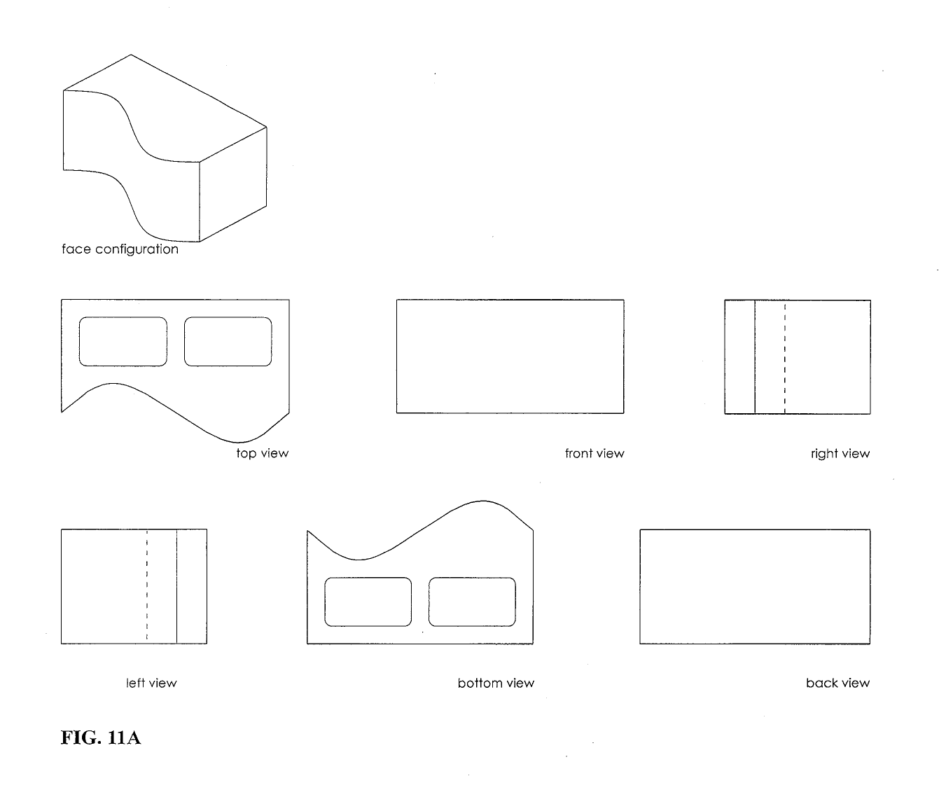

As illustrated in FIGS. 10A-D, a Ripple Block may generally comprise a surface having an arced indentation and an arced protrusion. The arced indentation may have an apex, or point of furthest indentation, along one side edge of the concrete block, while the arced protrusion may have an apex, or point of furthest extension, along the opposite side edge of the concrete block. The amount of indentation of the arced indentation and the amount of extension of the arced protrusion may diminish as the arced indentation and arced protrusion extend away from their apexes. The arced indentation and arced protrusion may generally provide a rippling, wave-like structure to the surface of a side of the concrete block.

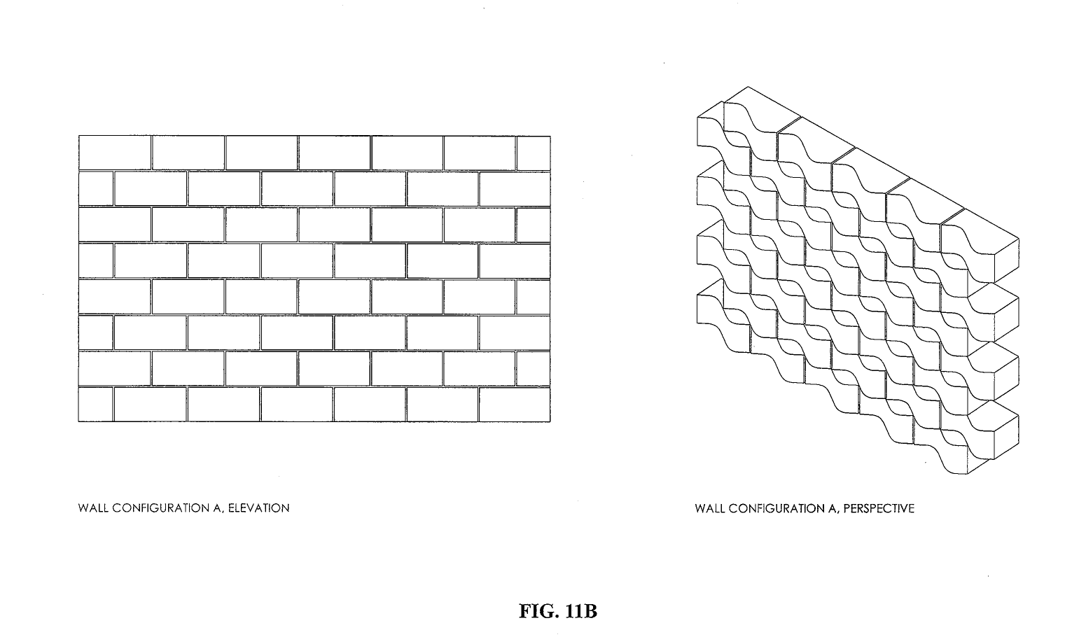

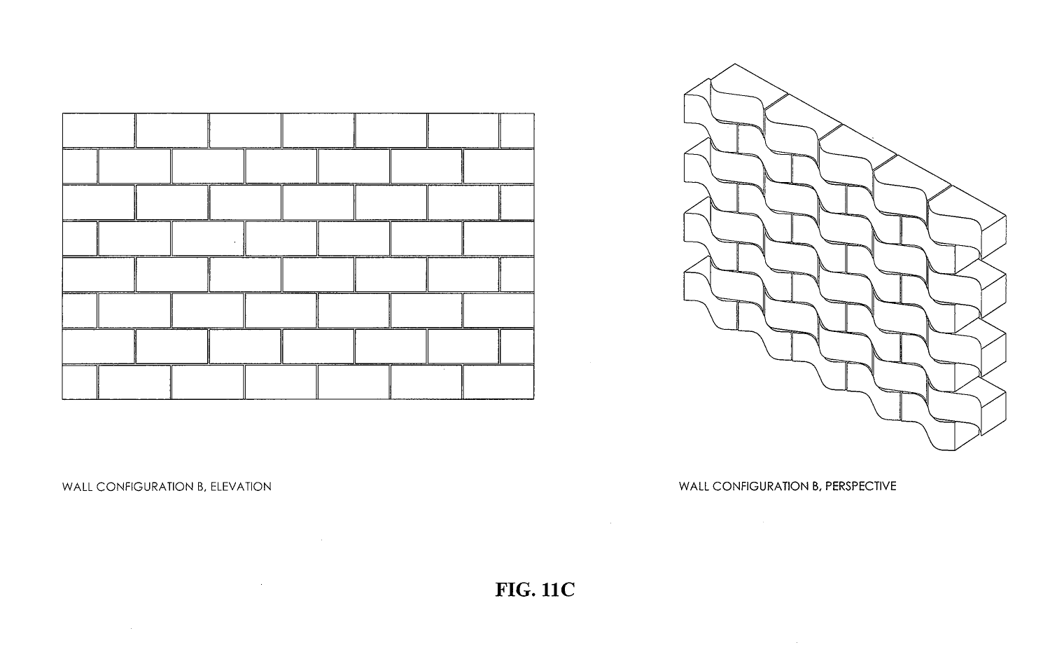

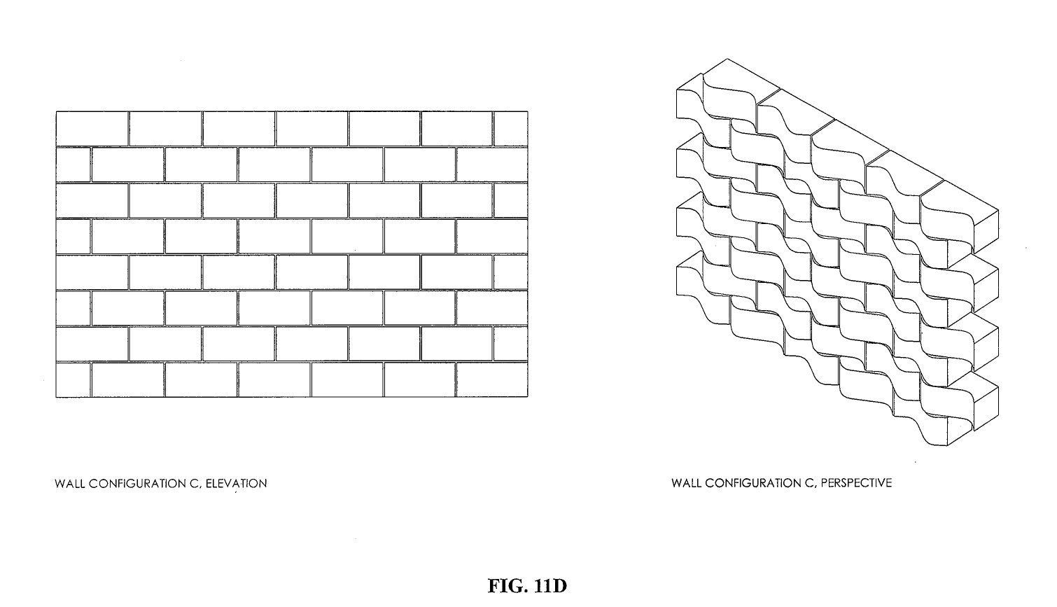

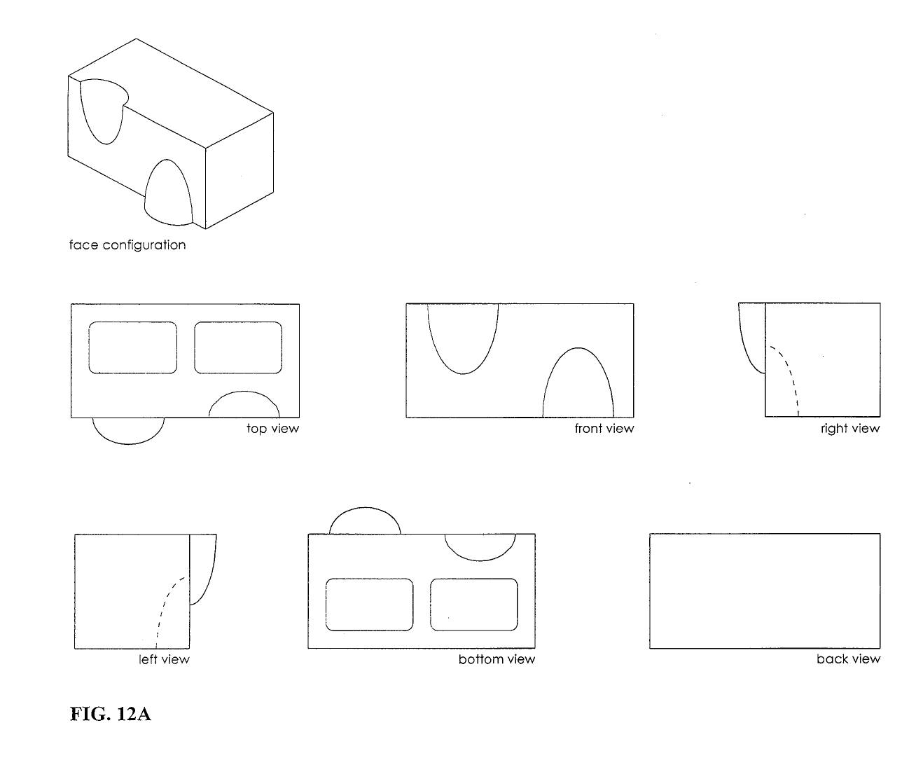

As illustrated in FIGS. 11A-D, a Sine Block may generally comprise a surface having an arced indentation in combination with an arced protrusion, such that a top or bottom view of the concrete block results in a sine wave-shaped edge.

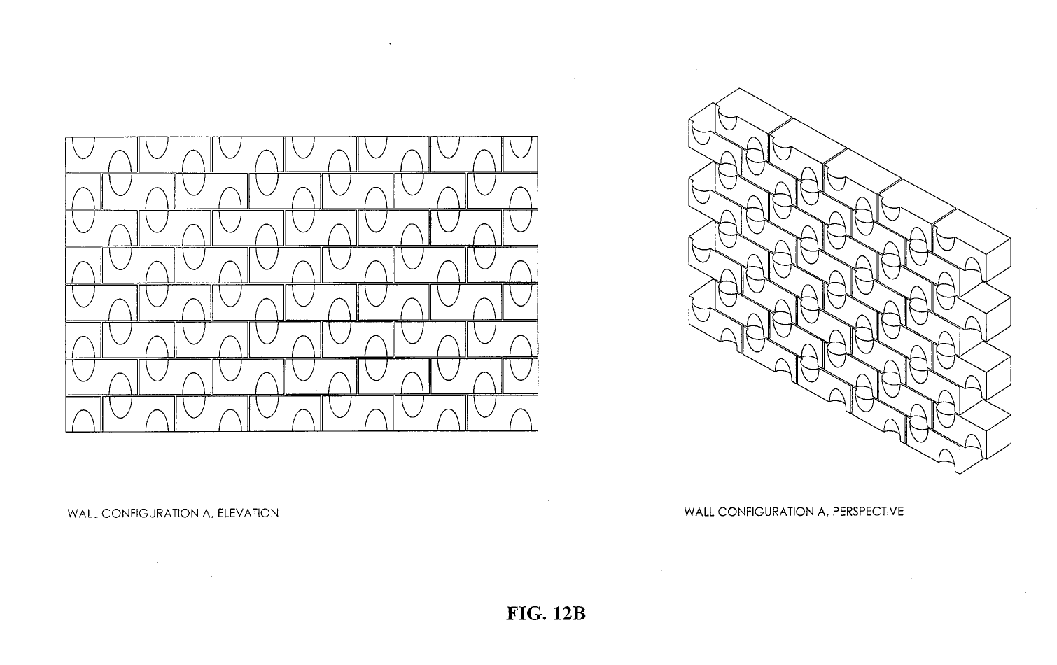

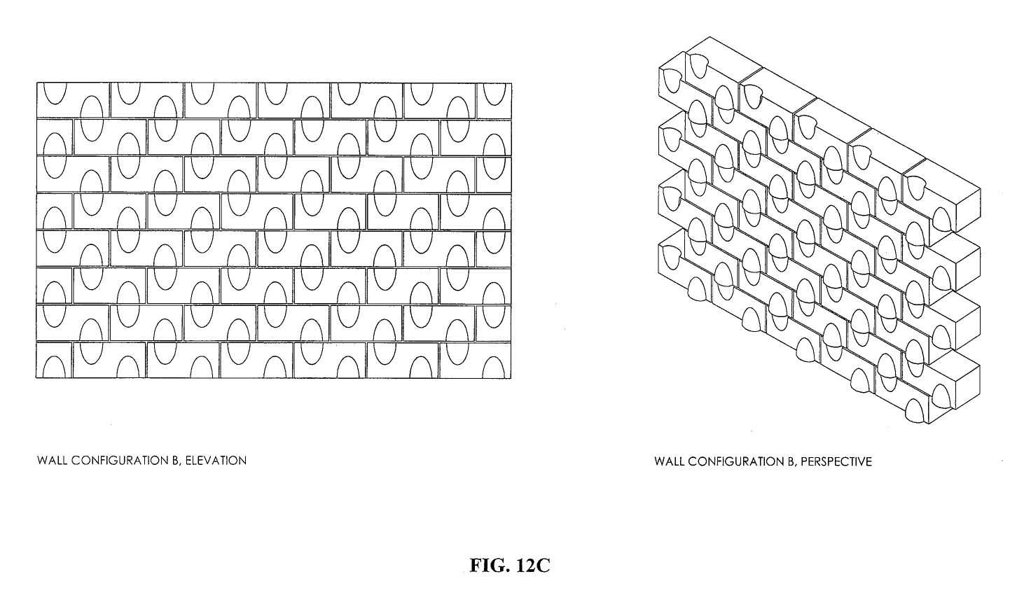

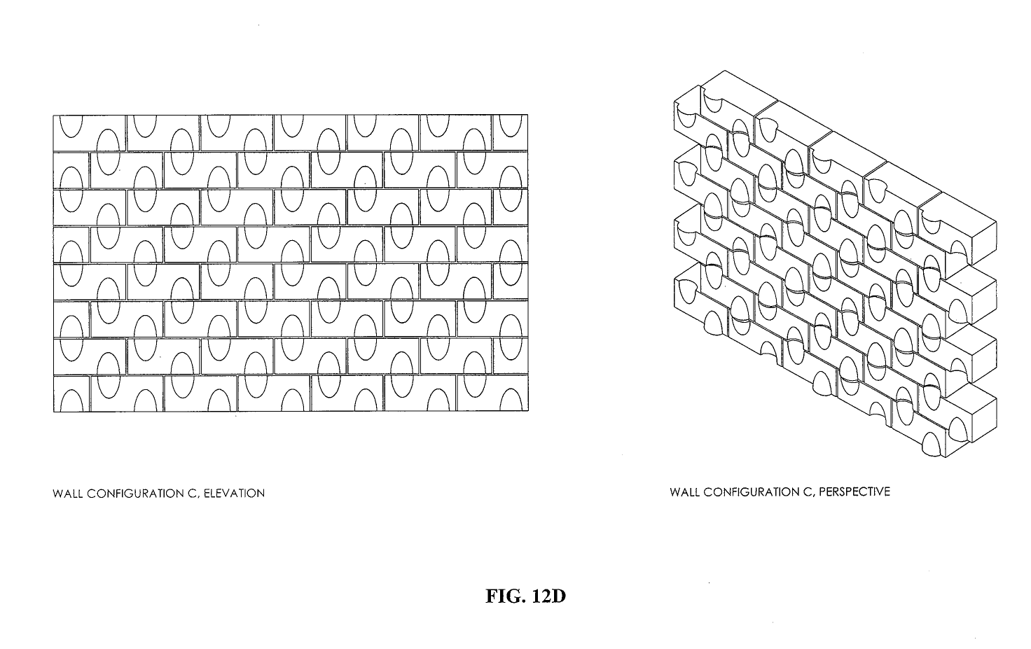

As illustrated in FIGS. 12A-D, an Egg Block may comprise one or more indentations or protrusions generally in the shape of a cross section of one half of an egg. In one embodiment, an Egg Block may comprise one indentation and one protrusion. The indentations or protrusions may be oriented such that the widest part of the indentation or protrusion intersects with a side edge of the concrete block.

Although the present invention has been described with reference to preferred embodiments, persons skilled in the art will recognize that changes may be made in form and detail without departing from the spirit and scope of the invention. For example, the blocks may be used to create alternate wall patterns than those illustrated in the Figures, including any designed, staggered, or random pattern, etc. Furthermore, the particular features of each facial structure described herein may be located at any location on the face of one or more sides of a concrete block. Furthermore, any of the facial structures may be used for retaining wall blocks, or any other suitable structural or nonstructural blocks.

We claim:

1. A concrete block comprising a combination of one or more of limestone, volcanic ash, shellfish shells, seashells, rice hull ash, slag, and fly ash.

2. The concrete block of claim 1, wherein the concrete block is a Socket Block.

3. The concrete block of claim 1, wherein the concrete block is a Fold Block.

4. The concrete block of claim 1, wherein the concrete block is a Bracket Block.

5. The concrete block of claim 1, wherein the concrete block is a Bracket Block.

6. The concrete block of claim 1, wherein the concrete block is an Awning Block.

7. The concrete block of claim 1, wherein the concrete block is a Chisel Block.

8. The concrete block of claim 1, wherein the concrete block is a Spade Block.

9. The concrete block of claim 1, wherein the concrete block is a Shim Block.

10. The concrete block of claim 1, wherein the concrete block is a Pachinko Block.

11. The concrete block of claim 1, wherein the concrete block is a Tornado Block.

12. The concrete block of claim 1, wherein the concrete block is a Ripple Block.

13. The concrete block of claim 1, wherein the concrete block is a Sine Block.

14. The concrete block of claim 1, wherein the concrete block is an Egg Block.
